(19) United States
(12) Patent Application Publication
(10) Pub. No.: US 2025/0172528 A1
(43) Pub. Date: May 29, 2025

(54) SYSTEM, METHOD AND SEPARATING COLUMN FOR SEPARATING SUBSTANCES IN A SUBSTANCE MIXTURE

(71) Applicant: PLASMION GMBH, Augsburg (DE)

(72) Inventor: Jan-Christoph WOLF, Ingolstadt (DE)

(73) Assignee: PLASMION GMBH, Augsburg (DE)

(21) Appl. No.: 18/843,170

(22) PCT Filed: Mar. 8, 2023
(86) PCT No.: PCT/EP2023/055902

§ 371 Date: Aug. 30, 2024

(30) Foreign Application Priority Data
Mar. 9, 2022 (DE) 10 2022 105 562.0

(51) Int. Cl. G01N 30/54; B01D 15/38; G01N 30/62

(52) U.S. Cl. CPC G01N 30/54; B01D 15/3876; G01N 30/62; B01D 2311/103

(57) ABSTRACT

The invention relates to a system for separating substances in a substance mixture. The system comprises a radiation source and a separation column. The separation column comprises at least a first section, the first section comprising at least a first subsection and a second subsection. The radiation source is configured to radiate electromagnetic radiation in the direction of the first section to heat the first section, wherein the electromagnetic radiation comprises infrared radiation. The electromagnetic radiation is receivable in the first subsection of the separation column with a higher intensity than in the second subsection of the separation column, so that the first subsection is heatable more intensively than the second subsection and a temperature gradient can be formed at least in sections along the first section (21) of the separation column (20).

### TECHNICAL FIELD

The present disclosure relates to a system for separating substances in a substance mixture. Further, the present disclosure relates to a method for separating substances in a substance mixture as well as a method for analyzing substances in a substance mixture. Another aspect of the present disclosure relates to a separation column for separating substances in a substance mixture.

### BACKGROUND ART

Separation columns for separating substance mixtures are known from the prior art. The substance mixture may be applied to a separation column to separate substances in the substance mixture. Usually, the substance mixtures are applied to the separation column together with a carrier fluid (gas or liquid) and carried by a pressure gradient from an inlet of the separation column along the separation column to an outlet of the separation column. In this course, different substances of the substance mixture interact (adsorption) with different strengths with the separation column or a separation column material, respectively, so that the substances of the substance escape mixture the outlet of the separation column at different points of time. At the outlet of the separation column, a detector for analyzing the substances may be arranged.

Typically, the separation columns are arranged in a column furnace. While the substance mixture is carried along the separation column, the temperature in the furnace is often increased to shift the balance of interaction of the substances of the substance mixture in the direction of desorption. Through an increase in temperature, typically, also a desorption of substances of the substance mixture is promoted, so that the substances are carried with the carrier fluid. In this course, a large temperature difference, for example, 300° C., may exist between the point of time of applying the substance mixture to the separation column (starting time) and the point of time of the substances of the substance mixture escaping the separation column (end time). For subsequent separation, the column furnace must be cooled again to the temperature for the starting time. Depending on the temperature of the starting time and the cooling capabilities of the column furnace, a considerable period of time may be necessary to cool the column furnace and get the system ready for a next separation.

From DE 197 07 114 C1, a gas chromatograph is known, wherein a heat lamp is used to heat the separation column.

### SUMMARY OF THE DISCLOSURE

An object of the invention is to provide a separation of substances in a substance mixture that is quick and can simultaneously be performed with high resolution. Another object of the invention is to facilitate and/or accelerate a handling of a separation column, for example a replacement of a separation column and/or a storage of a separation column.

At least one of the objects is solved by the feature combination of the independent claims. Preferred embodiments are defined in the dependent claims.

A system for separating substances in a substance mixture is disclosed. The system may comprise a radiation source and a separation column. The separation column may comprise at least a first section. The first section may comprise at least a first subsection and a second subsection. The radiation source may be configured to radiate electromagnetic radiation in the direction of the first section to heat the first section. The electromagnetic radiation may be receivable in the first subsection of the separation column with a higher intensity than in the second subsection of the separation column, so that the first subsection is heatable more intensively than the second subsection.

Because the electromagnetic radiation is received with different intensity of different sections of the separation column, a temperature gradient is established along the separation column. This temperature gradient leads to constant refocusing the substances during the separation and causes a better separation capability. Thereby, with shorter columns, the system may reach the same separation capability as a conventional system, but in significantly shorter analysis times.

Additionally, within the disclosed system, only the separation column may be heated directly, resulting in a low thermal mass, which allows for rapid cooling down. Further, the heating power may terminate immediately when turning off the radiation source. Similarly, the heating based on electromagnetic radiation may allow a complex geometry of the separation column (complex column routing). Also, in the separation column, a temperature gradient may be allowed only in sections.

Since the separation column, as a difference from resistive heating, is not connected to the heating member, a replacement of the separation column is possible more easily and in a less complicated manner than in known systems.

The separation column may be supported in a chip mount. The chip mount allows a quick and tool-free replacement of the separation column. This facilitates the handling and also allows the deployment of different selective phases, column lengths, and/or materials. Known fast substance separation systems (e.g., gas chromatography systems) are, in part, strongly limited here, especially regarding the separation column length, the separation column diameter, and/or the separation column material. So, only metal columns may be deployed in some substance separation systems.

By using electromagnetic radiation as a heating source may further reduce the space requirements. This allows for a compact design. Known substance separation systems (e.g. gas chromatographic system), in parts, have large space requirements. The compact design allows for a mobile deployment of the disclosed system in, for example, the on-site detection of hazardous substances or the narcotics detection.

In general, the system may be a gas chromatographic system. The substance mixture may exist at least partly in gas form. Specifically, the substance mixture in the separation column exists at least partly and/or at least temporarily in gas form.

Through an inlet of the separation column, a carrier gas may be applicable to the separation column. The carrier gas may be hydrogen (H₂), helium (He), nitrogen (N₂), argon (Ar), and/or carbon dioxide (CO₂). Specifically, the carrier gas is an inert gas.

The substance mixture may be applied to the separation column through, for example, an injector. Preferably, the carrier gas flows through the separation column, and the substance mixture is introduced into the flow of the carrier gas, to be transported by the carrier gas along the separation column.

The substance mixture may comprise at least two substances to be separated. The substance mixture may comprise a plurality of substances as well. The substances may be different chemically and/or physically. For example, the substances are different molecules. At least two of the substances in the substance mixture may be separable by the system. That is, not all substances of the substance mixture must be separated by the separation column.

In general, a separation of substances in the substance mixture may mean that the substance mixture is applied to the separation column at an (identical) point of time as the substances, and the substances to be separated or the separated substances, respectively, flow out from the separation column at different points of time.

The radiation source may generate electromagnetic radiation, especially to irradiate at least the first section of the separation column or to emit electromagnetic radiation in the direction of at least the first section of the separation column. The radiation source may be a lamp, especially a heat lamp. The electromagnetic radiation may comprise light in the infrared wavelength range (wavelengths between 780 nm and 1 mm). The electromagnetic radiation may comprise light in the visible wavelength range (wavelengths between 380 nm and 780 nm). Alternatively, the electromagnetic radiation may comprise light outside the visible wavelength range. Specifically, an intensity maximum of the electromagnetic radiation lies in the infrared wavelength range, in the visible wavelength range, or outside the visible wavelength range.

The radiation source may have a power of at least 1 W (watts), more preferably at least 5 W, more preferably at least 10 W, more preferably at least 25 W, more preferably at least 50 W, more preferably at least 75 W, more preferably at least 100 W. Specifically, the radiation source has a power between 1 W and 1000 W, preferably between 5 W and 500 W, more preferably between 5 W and 250 W, more preferably between 5 W and 100 W. The radiation source may be drivable by electric energy to generate the electromagnetic radiation. In other words, the radiation source may be configured to convert electric energy to electromagnetic radiation.

The radiation source may be formed in a bar shape. Preferably, the radiation source is configured to radiate electromagnetic radiation in a circumferential angle range of at least 180°, preferably at least 270°, more preferably at least 330°. Particularly preferably, the radiation source is configured to radiate electromagnetic radiation substantially (±10% or ±5%) over their full extent.

The radiation source may have a larger longitudinal development than lateral development. In a cylinder coordinate system, the longitudinal development may be the z direction, and the lateral development may be the r direction. Specifically, the longitudinal development of the radiation source is at least 1.5 times, preferably at least 2.0 times, more preferably at least 3.0 times, more preferably at least 4.0 times, more preferably at least 5.0 times as large as the lateral development of the radiation sources. In a case where the longitudinal development is 10 mm and the longitudinal development is at least 1.5 times as large as the lateral development, the lateral development is at least 15 mm.

The radiation source may be formed planarly. The radiation source may comprise a side configured to emit electromagnetic radiation. A side opposite this side may not be configured to emit electromagnetic radiation. The radiation source may be configured to radiate electromagnetic radiation emanating from exactly one side. The radiation source may be a round lamp, a surface emitter, or a lamp array. The side of the radiation source, from which electromagnetic radiation is emittable, may be formed substantially (±10% or ±5%) planarly.

In general, the area or the side of the radiation source, from which electromagnetic radiation is emittable, may have an area of at least 100 mm², preferably at least 250 mm², more preferably at least 500 mm², more preferably at least 750 mm², more preferably at least 1000 mm². The area of the side of the radiation source, from which electromagnetic radiation is emittable, may alternatively or additionally have an area of at most 10000 mm², preferably at most 7500 mm², more preferably at most 5000 mm², more preferably at most 2500 mm², more preferably at most 1000 mm².

The radiation source may be configured to emit electromagnetic radiation with different power at different points of time. The power of the electromagnetic radiation emitted by the radiation source may be controllable, especially by a control device or a controller of the system. For example, the radiation source may emit electromagnetic radiation with lower power when the substance mixture is applied to the separation column, and the radiation source may emit electromagnetic radiation with higher power after the substance mixture has been applied to the separation column. The radiation source may be configured to generate a temperature profile or a temperature program in the separation column. In a temperature profile or a temperature program, the temperature at a location of the separation column may be different at different points of time. In the separation column, a (temporal) temperature profile or temperature program may be generatable by the radiation source.

The heating of the separation column may occur to at least 80%, preferably to at least 85%, more preferably to at least 90%, more preferably to at least 95%, more preferably to at least 98% by the (electromagnetic radiation of the) radiation source. Specifically, the beating the separation column occurs fully or exclusively by the (electromagnetic radiation of the) radiation source.

The separation column may be heatable or heated not by conduction and/or not by convection.

The separation column may be a capillary, especially a layer capillary (PLOT column, porous layer open tubular column), a support-coated capillary (SCOT column, support-coated open tubular column), a thin-film capillary (WCOT column, wall-coated open tubular column) or a FSOT column (fused-silica open tubular column). The separation column may be a packed or an unpacked separation column. The separation column may be a polar or an unpolar separation column. The separation column may be coated inside with a stationary phase. The separation column may be formed tube-shaped or capillary shaped.

The inner diameter of the separation column may be between 0.01 mm and 5.0 mm, preferably between 0.01 mm and 3.0 mm, more preferably between 0.05 mm and 1.0 mm, more preferably between 0.05 mm and 0.80 mm, more preferably between 0.10 mm and 0.32 mm. The length of the separation column may at least be 10 cm, preferably at least 30 cm, more preferably at least 50 cm, more preferably at least 1.0 m, more preferably at least 2.5 m, more preferably at least 5 m, more preferably at least 10 m, more preferably at least 15 m. Alternatively or additionally, the length of the separation column may be at most 100 m, preferably at most 75 m, more preferably at most 50 m, more preferably at most 25.0 m, more preferably at most 15.0 m, more preferably at most 5.0 m, more preferably at most 2.5 m. Specifically, the length of the separation column is between 2.0 m and 20.0 m, preferably between 3.0 m and 15.0 m.

The separation column comprises at least a first section. The first section may be at least 30%, preferably at least 40%, more preferably at least 50%, more preferably at least 60%, more preferably at least 70%, more preferably at least 80%, more preferably at least 90% of the overall length of the separation column. The first section may be wrapped, especially around a central axis of the separation column. The first section may be wrapped in a coil shape or helical shape. Alternatively, the first section may be wrapped in a spiral shape. In a coil-shaped or helically shaped winding, the height position of the first section of the separation column may change (enlarge or reduce) with increasing column length. In a spirally shaped winding, the height position of the first section of the separation column may not change with increasing column length. In other words, in a spirally shaped winding, the first section may be wrapped substantially in a plane. In a helically shaped or coil-shaped winding, the first section may extend upwards or downwards perpendicular to a plane. If the first section is wrapped in a coil shape or a helical shape, a height of the first section may at least be 1.0 mm, preferably at least 5 mm, more preferably at least 10 mm, more preferably at least 20 mm, more preferably at least 50 mm, more preferably at least 100 mm.

The first section of the separation column may comprise at least two, preferably at least five, more preferably at least ten, more preferably at least fifteen, more preferably at least twenty full windings.

The first section of the separation column may surround the radiation source. Alternatively, the first section may not surround the separation column. Specifically, the first section of the separation column surrounds the radiation source when the first section is formed in a coil shape or a helical shape. Similarly, the first section of the separation column may not surround the radiation source when the first section is formed in a coil shape or helical shape. In a case where the first section of the separation column is formed in a spiral shape, the first section may not surround the radiation source.

The first section may comprise a length (length along the separation column) of at least 10 mm, preferably at least 25 mm, more preferably at least 50 mm, more preferably at least 75 mm, more preferably at least 100 mm, more preferably at least 150 mm, more preferably at least 200 mm, more preferably at least 300 mm, more preferably at least 400 mm, more preferably at least 500 mm, more preferably at least 1000 mm.

The first section of the separation column may comprise a first subsection and a second subsection. The first subsection and the second subsection may receive electromagnetic radiation emanating from the radiation source. In other words, the first subsection and the second subsection may be irradiated by the radiation source with the electromagnetic radiation. By the electromagnetic radiation, the first subsection and the second subsection may be heated. Specifically, a surface of the first subsection and of the second subsection, respectively, may absorb at least a portion of the electromagnetic radiation. Thereby, the first subsection and the second subsection may be heated.

The first subsection of the separation column and the second subsection of the separation column may receive the electromagnetic radiation with a different intensity. For example, the first subsection may receive the electromagnetic radiation with a higher intensity than the second subsection. The difference in the received intensity of the electromagnetic radiation may be at least 0.1%, preferably at least 0.5%, more preferably at least 1%, more preferably at least 5%, more preferably at least 10%, more preferably at least 20%, more preferably at least 30%, more preferably at least 40%, more preferably at least 50%. Specifically, the electromagnetic radiation in the first subsection of the separation column may be receivable with an at least 1% higher, preferably at least 2% higher, more preferably at least 5% higher, more preferably at least 7% higher, more preferably at least 10% higher, more preferably at least 12% higher, more preferably at least 15% higher, more preferably at least 20% higher, more preferably at least 25% higher, more preferably at least 30% higher intensity than in the second subsection. Thereby, the first subsection may be heatable more intensively than the second subsection.

The first subsection and/or the second subsection may have a length of at least 1 mm, preferably at least 2 mm, more preferably at least 5 mm, more preferably at least 10 mm. In the first subsection and/or in the second subsection, a (continuous) temperature gradient may be formed, especially by a (continuous) difference in the receivable intensity of the electromagnetic radiation.

Preferably, a temperature gradient is formed along (the first section) of the separation column at least in sections. In this course, the temperature upstream may be higher than downstream. In other words, the temperature closer to the inlet may be higher than closer to the outlet of the separation column.

In general, the intensity, at which the electromagnetic radiation is receivable in the first subsection and in the second subsection, may be understood as power per area (e.g., W/m²). Thus, with identical areas of the first subsection and the second subsection, a higher power of the electromagnetic radiation may be receivable in the first subsection than in the second subsection.

The first section of the separation column may comprise more than two subsections, for example at least three, at least five or at least ten subsections. In each of the subsections, the electromagnetic radiation may be receivable with a different intensity.

Preferably, the electromagnetic radiation in the first section of the separation column is receivable such that a (continuous) temperature gradient is established along at least a section of the first section. The (continuous) temperature gradient may be formable between the first subsection and the second subsection.

Between the inlet of the separation column and the outlet of the separation column, a (continuous) temperature gradient may be formable or be formed, especially by the radiation source. A (continuous) temperature gradient may be formed over the whole length of the separation column.

In general, at a temperature gradient, a temperature difference of at least 1° C., preferably at least 5° C., more preferably at least 10° C., more preferably at least 20° C., more preferably at least 40° C., more preferably at least 70° C., more preferably at least 100° C., may be formed. The temperature difference may exist between a position of the separation column where the temperature gradient begins and a position of the separation column where the temperature gradient ends.

For the determination of the temperature difference, the temperature at a first position of the separation column may be compared to a temperature at a second position of the separation column. The first position of the separation column may be the inlet of the separation column. The second position of the separation column may be the outlet of the separation column. Between the first position of the separation column and the second position of the separation column may be an interval (along the separation column) of at least 10 mm, preferably at least 50 mm, more preferably at least 100 mm, more preferably at least 200 mm, more preferably at least 300 mm, more preferably at least 500 mm, more preferably at least 1000 mm.

Between the first subsection and the second subsection may be an interval along the separation column of at least 10 mm, preferably at least 50 mm, more preferably at least 100 mm, more preferably at least 200 mm, more preferably at least 300 mm, more preferably at least 500 mm, more preferably at least 1000 mm.

The first section of the separation column may be spaced from the radiation source. Specifically, the first section of the separation column does not contact the radiation source.

An interval may be formed between the first subsection and the radiation source. Alternatively or additionally, an interval may be formed between the second subsection and the radiation source. An interval between the first subsection and the radiation source may be smaller than an interval between the second subsection and the radiation source. The interval may be a shortest interval. In other words, the first subsection may be (spatially) closer to the radiation source than the second subsection.

Preferably, the interval between the first subsection and the radiation source is about at least 1 mm, preferably about at least 2 mm, more preferably about at least 5 mm, more preferably about at least 10 mm smaller than the interval between the second subsection and the radiation source.

The interval between the first subsection and the radiation source may be at least 1.0 mm, preferably at least 2.5 mm, more preferably at least 5 mm, more preferably between 1 mm and 20 mm, more preferably between 5 mm and 15 mm, more preferably about 10 mm. Alternatively or additionally, the interval between the second subsection and the radiation source may be at least 5 mm, preferably at least 10 mm, more preferably between 10 mm and 30 mm, more preferably about 20 mm.

The separation column, especially the first section of the separation column, may extend conically at least in sections. The separation column, especially the first section of the separation column, may be formed conically at least in sections. The interval between the separation column and the radiation source, especially between the first section of the separation column and the radiation source, may increase or decrease (continuously) along the separation column, especially along the first section of the separation column.

The separation column, especially the first section of the separation column, may extend, at least in sections, cylindrically, linearly, hyperbolically or as mixtures thereof.

In the first section, an interval between the separation column and the radiation source may increase or decrease at least in sections. The interval between the separation column and the radiation source may increase or decrease over a length of the separation column or along the separation column of at least 10 mm, preferably at least 25 mm, more preferably at least 50 mm, more preferably at least 75 mm, more preferably at least 100 mm, more preferably at least 150 mm, more preferably at least 200 mm, more preferably over the length of the whole first section.

The separation column may be formed rigidly or fixed at least in the first section. For example, the separation column may be adhered in at least the first section. In this course, neighboring or adjacent winding sections of the first section may be adhered to each other. Thereby, the first section of the separation column may be rigid, fixed, or immobile.

Similarly, the separation column may be, at least in the first section, movable or variable in its shape. The separation column or adjacent or adjacent winding sections of the first section, respectively, may be not connected to each other. Through a change of the shape of the first section of the separation column, intervals between sections of the separation column and the radiation source may be variable. Thereby, the temperature profile along the separation column may be adjustable or tuned to a separation task, respectively.

The system may comprise a mount. The separation column may be held by the mount at least in sections. Through the mount, a positioning of at least the first section of the separation column may be designated or be designatable relative to the radiation source. The mount may be a chip mount or a click mount. In a chip mount or a click mount, the separation column may chipped in or clicked in.

The mount may be adjustable. In adjusting the mount, a shape of the separation column may change at least in the first section. By the change of the shape of the separation column at least in the first section, intervals between sections of the first section of the separation column and the radiation source may be changed.

Through the change of the shape of the separation column, especially by a change of the shape of the separation column at least in the first section, the intensity of the electromagnetic radiation receivable in the first subsection and/or in the second subsection may change.

The separation column may be provided with a coating at least in sections, for example, in the first section or a partial section of the first section. The coating may impact the intensity of the receivable electromagnetic radiation.

The coating may be a coating by which the absorption and/or reflection of electromagnetic radiation is changed. For example, the coating may increase or reduce the absorption of electromagnetic radiation of the radiation source. Similarly, the coating may increase or reduce the reflection of electromagnetic radiation of the radiation source.

The coating may be a metallic coating, for example, a gold or silver coating. The coating may be a graphite coating. The coating may be evaporated on or sprayed on at least a section of the separation column. Similarly, the coating may be applied (in liquid form) to at least a section of the separation column.

The coating may be applied in the first subsection of the separation column and the coating may not be applied in the second subsection of the separation column. Similarly, the coating may be applied in the second subsection of the separation column and the coating may not be applied in the first subsection of the separation column.

Specifically, the coating may be applied to (a section of) the separation column when the interval between the separation column and the radiation source in the first section is constant. The coating may be applied to the first subsection or the second subsection when the interval between the first subsection and the radiation source is substantially (±10% or ±5%) identical to the interval between the second subsection and the radiation source.

The coating (the separation column) may impact the absorption and/or reflection of the electromagnetic radiation.

The radiation source may comprise a first section and the radiation source may comprise a second section. The first section may be configured to emit or to radiate electromagnetic radiation in the direction of the first subsection with a higher intensity than the second section is configured to emit or to radiate electromagnetic radiation in the direction of the second subsection. In other words, the radiation source may be configured to emit or to radiate electromagnetic radiation in the direction of the first section of the separation column with different intensity. The radiation source may emit or radiate electromagnetic radiation in the direction of the first subsection with higher intensity than in the direction of the second subsection. Thereby, the first subsection of the separation column may be heated more intensively than the second subsection.

The radiation source may be provided with a coating at least in the first section. Alternatively or additionally, the radiation source may be provided with a coating at least in the second section.

The coating may be a coating through which the absorption and/or reflection of electromagnetic radiation changes. For example, may coating the absorption of electromagnetic radiation increase or reduce. Similarly, the coating may increase or reduce the reflection of electromagnetic radiation of the radiation source.

The coating may be a metallic coating, for example, a gold or silver coating. The coating may be a graphite coating. The coating may be evaporated on or sprayed on at least a section of the separation column. Similarly, the coating may be applied (in liquid form) at least to a section of the separation column.

The coating may be applied in the first section of the radiation source and the coating may not be applied in the second section of the radiation source. Similarly, the coating may be applied in the second section of the radiation source and the coating may not be applied in the first section of the radiation source.

Specifically, the coating may be applied to (a section) of the radiation source when the interval between the separation column and the radiation source in the first section is constant. The coating may be applied to the first subsection or the second subsection when the interval between the first subsection and the radiation source is substantially (±10% or ±5%) identical to the interval between the second subsection and the radiation source.

The radiation source may comprise a transparent element. The electromagnetic radiation generated by the radiation source may pass through the transparent element. The transparent element may comprise glass or a plastic or consist of glass or plastic.

The transparent element may comprise a first section and a second section. The transmissive properties regarding the electromagnetic radiation may differ in the first section of the transparent element and the second section of the transparent element. For example, the composition of the material of the transparent element in the first section of the composition may differ from the material of the transparent element in the second section. In the first section, the electromagnetic radiation may pass through the transparent element with a higher intensity than in the second section.

The first section of the transparent element may radiate or emit electromagnetic radiation in the direction of the first subsection of the separation column. The second section of the transparent element may radiate or emit electromagnetic radiation in the direction of the second subsection of the separation column. Thereby, the first subsection of the separation column may be heated more intensively than the first subsection of the separation column.

Specifically, the transparent element may comprise glass or consist thereof. The first section of the transparent element may be doped differently from the second section of the transparent element. By the different doping, the first section of the transparent element may emit or radiate electromagnetic radiation with a higher intensity in the direction of the first subsection of the separation column than the second section of the transparent element emits or radiates electromagnetic radiation in the direction of the second subsection of the separation column.

A shield member may be arranged between the radiation source and the separation column. The shield member may be configured to shield part of the electromagnetic radiation of the radiation source.

For example, a first section of the radiation source may emit or radiate electromagnetic radiation with substantially (±10% or ±5%) the same intensity in the direction of the first subsection of the separation column as a second section of the radiation source emits or radiates electromagnetic radiation in the direction of the second subsection. The shield member may be arranged at least between the second section of the radiation source and the second subsection of the separation column. Thereby, the second subsection of the separation column may receive electromagnetic radiation with a lower intensity than the first subsection of the separation column. Between the first section of the radiation source and the first subsection of the separation column, no shield member may be arranged, or a shield member arranged between the first section of the radiation source and the first subsection of the separation column may shield the electromagnetic radiation less strongly than the shield member between the second section of the radiation source and the second subsection of the separation column.

The shield member may comprise a first section and a second section. The first section may be configured to shield electromagnetic radiation of the radiation source less strongly than the second section. Through the first section of the shield member, electromagnetic radiation of the radiation source may radiate in the direction of the first subsection of the separation column. Through the second section of the shield member, electromagnetic radiation of the radiation source may radiate in the direction of the second subsection of the separation column. Thereby, the first subsection of the separation column may receive electromagnetic radiation with a higher intensity than the second subsection of the separation column, whereby the first subsection of the separation column may be heated more intensively than the second subsection of the separation column.

The shield member may be an opacity element, a filter, a semitransparent element, and/or an element with a coating. The transmissive properties for the electromagnetic radiation of the radiation source may differ in a first section of the shield member and in a second section of the shield member.

In general, the electromagnetic radiation of the radiation source may comprise infrared radiation or have an intensity maximum in the infrared wavelength range.

The first section of the separation column may surround the radiation source. Specifically, the first section of the separation column fully surrounds the radiation source.

The system may comprise a detector. The detector may be configured to analyze a property of substances in the substance mixture. Specifically, the detector may be arranged at the outlet of the separation column. The detector may be configured to analyze at least one property of a substance, wherein the substance was separated from the substance mixture by the separation column.

The detector may be a flame-ionization detector (FID), a thermal-conductivity detector (WLD), a photoionization detector (PID), a flame-photometric detector (FPD), a nitrogen-phosphorus detector (NPD), a thermionic detector (TID), a electron capture detector (ECD), a pulsed charge detector (PD), an atomic emission detector (AED), a Echelle plasma emission detector (EPED), mass spectrometers (MS), and/or an ion-mobility spectrometer (IMS). Particularly preferably, the detector is an ion-mobility spectrometer or a mass spectrometer.

Disclosed is a method for the separation or fractionation of substances in a substance mixture. The method comprises introducing the substance mixture to an inlet of a separation column; radiating electromagnetic radiation emanating from a radiation source to at least a first section of the separation column to heat the first section, wherein the separation column receives the electromagnetic radiation in a first subsection of the first section with a higher intensity than in a second subsection of the first section, so that the first subsection is heated more intensively than the second subsection; and deploying the separated substance mixture from an outlet of the separation column.

Each feature disclosed herein may be employed in the method. Specifically, each separation column and/or radiation source disclosed herein may be employed in the method.

Disclosed is a method for analyzing substances in a substance mixture. The method comprises conducting a method disclosed herein for separating or fractionating substances in a substance mixture; and detecting, by a detector, substances in the separated substance mixture.

Each feature disclosed herein may be employed in the method. Specifically, each separation column and/or radiation source and/or detector disclosed herein may be employed in the method.

Disclosed is a separation column for separating substances in a substance mixture. The separation column may comprise at least a first section wrapped around a central axis. The first section may comprise a first subsection and a second subsection. The first subsection may be configured to receive electromagnetic radiation with a higher intensity than the second subsection, so that the first subsection is heatable by the electromagnetic radiation more than the second subsection.

Each feature disclosed herein may be employed in the separation column. Specifically, the separation column may be each separation column disclosed herein, especially, the central axis may replace the radiation source in feature disclosed herein.

In a case where the separation column is wrapped in a spiral shape, the central axis may be oriented perpendicularly to the plane defined by the separation column, in which the separation column lies planarly. In a case where the separation column is wrapped in a coil shape or a helical shape, the central axis may be understood as an axis wrapped concentrically by the separation column.

The electromagnetic radiation may be receivable emanating from the central axis in the first subsection and the second subsection. Specifically, a radiation source may be arranged on the central axis or in the area of the central axis. Each radiation source disclosed herein may be employed to do so.

An interval between the first subsection and the central axis may be smaller than an interval between the second subsection and the central axis.

An interval may be formed between the first subsection and the central axis. Alternatively or additionally, an interval may be formed between the second subsection and the central axis. An interval between the first subsection and the central axis may be smaller than an interval between the second subsection and the central axis.

Preferably, the interval between the first subsection and the central axis is about at least 1 mm, more preferably about at least 2 mm, more preferably about at least 5 mm, more preferably about at least 10 mm smaller than the interval between the second subsection and the central axis.

The interval between the first subsection and the central axis may at least be 5 mm, preferably between 5 mm and 20 mm, more preferably between 5 mm and 15 mm, more preferably about mm. Alternatively or additionally, the interval between the second subsection and the central axis may be at least 5 mm, preferably at least 10 mm, more preferably between 10 mm and 30 mm, more preferably about 20 mm.

The separation column, especially the first section of the separation column, may extend conically at least in sections. The separation column, especially the first section of the separation column, may be formed conically at least in sections. The interval between the separation column and the central axis, especially between the first section of the separation column and the central axis, may increase or decrease (continuously) along the separation column, especially along the first section of the separation column.

The separation column, especially the first section of the separation column, may extend, at least in sections, cylindrically, linearly, hyperbolically or as mixtures thereof.

In the first section, an interval between the separation column and the central axis may increase or decrease at least in sections. The interval between the separation column and the central axis may increase or decrease over a length of the separation column or along the separation column of at least 1.0 mm, preferably at least 5 mm, more preferably at least 10 mm, more preferably at least 25 mm, more preferably at least 50 mm, more preferably at least 75 mm, more preferably at least 100 mm, more preferably at least 150 mm, more preferably at least 200 mm, more preferably through the length of the whole first section.

The separation column may be formed rigidly or in a fixed way at least in the first section. Similarly, the separation column may be movable or variable in its shape at least in the first section.

The separation column may be held by a mount at least in sections. By the mount, a positioning of at least the first section of the separation column relative to the central axis may be designated or be designatable.

The mount may be adjustable. In an adjusting the mount, a shape of the separation column may change at least in the first section. By the change of the shape of the separation column at least in the first section, intervals between sections of the first section of the separation column and the central axis may be changed.

By the change of the shape of the separation column, especially by a change of the shape of the separation column at least in the first section, the intensity of the electromagnetic radiation receivable in the first subsection and/or in the second subsection may change.

The separation column may be provided with a coating at least in sections, for example, in the first section or a partial section of the first section. The coating may impact the intensity of the receivable electromagnetic radiation.

The coating may be a coating through which the absorption and/or reflection of electromagnetic radiation is changed. For example, the coating may increase or reduce the absorption of electromagnetic radiation from a radiation source. Similarly, the coating may increase or reduce the reflection of electromagnetic radiation from a radiation source.

The coating may be a metallic coating, for example, a gold or silver coating. The coating may be a graphite coating. The coating may be evaporated on or sprayed on at least a section of the separation column. Similarly, the coating may be applied (in liquid form) to at least a section of the separation column.

The coating may be applied in the first subsection of the separation column and the coating may not be applied in the second subsection of the separation column. Similarly, the coating may be applied in the second subsection of the separation column and the coating may not be applied in the first subsection of the separation column.

Specifically, the coating may be applied to (a section of) the separation column when the interval between the separation column and the central axis in the first section is constant. The coating may be applied to the first subsection or the second subsection when the interval between the first subsection and the central axis is substantially (±10% or ±5%) identical to the interval between the second subsection and the central axis.

### BRIEF DESCRIPTION OF THE FIGURES

Subsequently, the disclosure and other embodiments and advantages of the disclosure, respectively, will be explained in more detail by means of figures, where the figures only describe embodiments of the disclosure. The same components in the figures will be denoted by the same reference signs. In the figures,

FIG. 1a shows a system 1000 for the analysis with a system 100 for separating substances in a substance mixture;

FIG. 2a shows a system 100 for separating substances in a substance mixture;

FIG. 3a shows a system 100 for separating substances in a substance mixture;

FIG. 4a shows a system 100 for separating substances in a substance mixture;

FIG. 5a shows a system 100 for separating substances in a substance mixture;

FIG. 6a shows a system 100 for separating substances in a substance mixture;

FIG. 7a shows a system 100 for separating substances in a substance mixture;

FIG. 8a shows a system 100 for separating substances in a substance mixture;

FIG. 9a shows a system 100 for separating substances in a substance mixture;

FIG. 10 shows a system 100 for separating substances in a substance mixture; and

FIG. 11 shows a system 100 for separating substances in a substance mixture.

### DETAILED DESCRIPTION

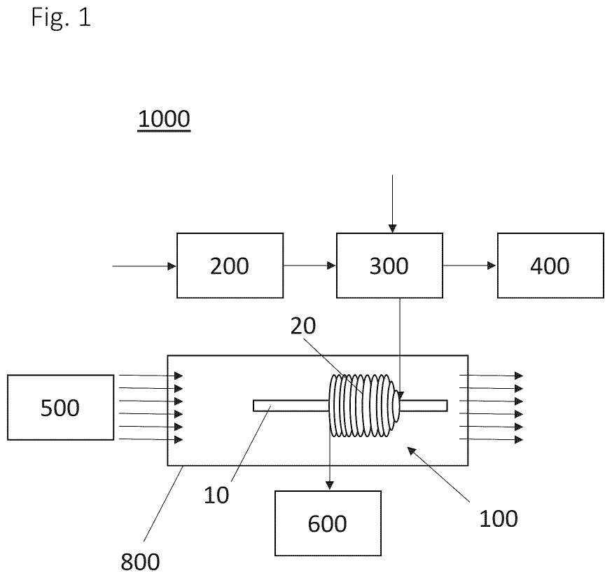

FIG. 1 shows a system 1000 for analyzing a substance (in the following also abbreviated to system 1000). By the system 1000, at least one substance of a substance mixture may be analyzed. In general, analyzing may mean that at least one physical or chemical property of a substance is determined.

The system 1000 may comprise a gas supply member 200, an injector 300, a valve 400, a system 100 for separating substances in a substance mixture (in the following also abbreviated to system 1000), a detector 600, and a fan 500. The system 1000 does not necessarily comprise any of the components, as shown in and described regarding FIG. 1. Rather, the system 1000 may comprise a component or some of the components and not comprise others of the components.

The gas supply member 200 may provide a gas supply of the system 1000. Specifically, a gas supply of the system 1000 may be controlled or regulated by the gas supply member 200. For example, the gas supply member 200 may provide a carrier gas.

In the injector 300, a substance mixture with different substances may be introduced to the system 1000. The substance mixture represents the sample to be examined. Particularly, the injector 300 may be connected to the gas supply member 200 and supplied with carrier gas by the same. At least a part of the substance mixture introduced to the injector 300 may be introduced to the system 100 with the carrier gas.

The valve 400 may control or regulate gas flows in the system 1000. Specifically, the valve 400 may control or regulate the carrier gas flow in addition or alternatively to the gas supply member 200.

In the system 100, the substance mixture and the carrier gas may be applied to the separation column 20. The separation column 20 may be heated by a radiation source 10. The substance mixture and the carrier gas may pass through the separation column 20. In passing through the separation column 20, substances in the substance mixture may be separated, so that different substances of the substance mixture flow out of the separation column 20 at different points of time.

The substances of the substance mixture flowing out of the separation column 20 may be introduced to the detector 600. In the detector 600, at least one property of at least one of the substances of the substance mixture may be analyzed.

While the substance mixture flows through the separation column 20, the temperature of the separation column 20 may be changed. For example, a start temperature or a start temperature profile for the separation column 20 may be predetermined. As soon as the substance mixture is applied to the separation column 20, the temperature in the separation column 20 may be increased in the direction of an end temperature or of an end temperature profile. This may occur through a predetermined temperature ramp. The increase of the temperature may occur through an increase of the power of the radiation source 10.

In a case where the end temperature or the end temperature profile at the end of a measurement is reached, i.e., when the separated substance mixture has flown out from the separation column in the direction of the detector 600, the temperature of the separation column for a subsequent measurement may be reduced to the start temperature or to the start temperature profile again. To do so, the system 1000 may comprise the fan 500.

The fan 500 may generate an air flow flowing around the system 100, especially the separation column 20. By the air flow, the separation column 20 may be cooled.

Additionally or alternatively to the fan 500, the system 1000 may comprise an active cooling (not depicted). The active cooling may cause a cooling of the separation column 20 by a cooling gas, e.g. carbon dioxide or nitrogen, or by a cooling member, e.g. a Peltier element. Thereby, the cooling time of the system may be reduced and/or an analysis of very volatile or gaseous, respectively, connections (e.g. Methan) may occur.

Similarly, a negative pressure (vacuum) may be applied to the outlet of the separation column 20. To do so, the system 1000 may comprise a negative pressure unit (not depicted). Such a method is known as Low Pressure Gas Chromatography (LPGC) as such. Thereby, the efficiency of the separation of substances in the substance mixture may be increased and/or the analysis time may be shortened.

The system 1000 may comprise a housing 800. In the housing 800, the system 100 may be arranged at least partly. The housing 800 may comprise a thermal insulating layer. Alternatively or additionally, the housing 800 may comprise a reflector. The reflector may reflect at least a part of the of the electromagnetic radiation generated by the radiation source 10.

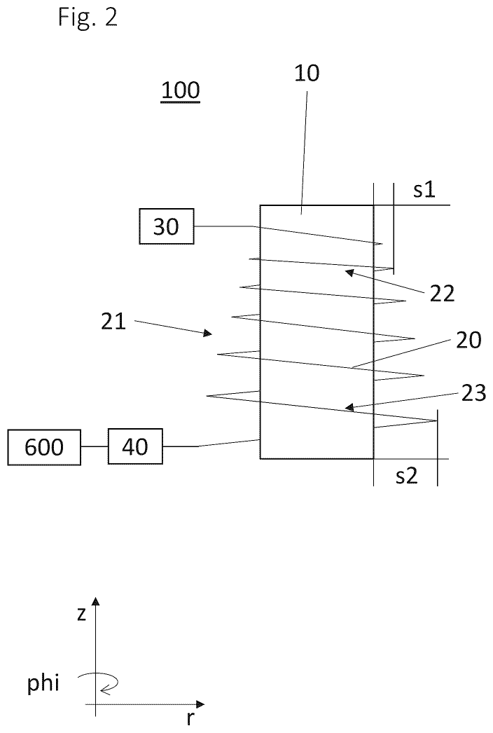

FIG. 2 shows a schematic depiction of the system 100. The system 100 comprises a radiation source 10 and a separation column 20. Additionally, the system 100 may comprise a detector 600. Through an inlet 30, e.g. through the injector 300 as depicted in FIG. 1, the separating substance mixture may be applied to the separation column 20. The substance mixture may flow through the separation column 20 to separate substances of the substance mixture. The separated substances of the substance mixture may flow out through an outlet 40, for example, to the detector 600.

The separation column 20 comprises a first section 21. In this example, the first section 21 of the separation column 20 is wrapped around the radiation source 10. The separation column 20 may be configured in a coil-shaped or helically shaped way at least in the first section 21.

The first section 21 of the separation column comprises a first subsection 22 and a second subsection 23. An interval s1 between the first subsection 22 and the radiation source 10 is smaller than an interval s2 between the second subsection 23 and the radiation source 10.

In this example, the radiation source 10 may be formed in a bar shape. The radiation source 10 may emit electromagnetic radiation with a same intensity throughout the radiation-emitting section of the radiation source 10.

Through the different intervals s1, s2 between the first subsection 22 and the radiation source 10 as well as the second subsection 23 and the radiation source, the first subsection 22 and the second subsection 23 are heated with different strengths.

Between the first subsection 22 and the second subsection 23 along the separation column 20, especially along the first section 21, the interval between the separation column 20 and the radiation source 10 may continuously change, for example, increase or decrease. Preferably, the interval between the separation column 20 and the radiation source 10 increases from the inlet 30 to the outlet 40. By the different intervals of the sections of the separation column 20 to the radiation source 10, a temperature gradient may occur along the separation column 20, especially along the first section 21 of the separation column 20. The temperature may decrease from the inlet 30 to the outlet 40. Thereby, a refocusing of the separated substances of the substance mixture at the outlet 40 is created.

In a cylinder coordinate system, the interval between the separation column 20 and the radiation source may exist in the radial direction (r direction). The radiation source 10 may extend in the axial direction (z direction). In the axial z direction, the height direction the coil-shaped or helically shaped wrapped separation column 20 may extend. The winding of the separation column 20 may exist in the circumferential direction (phi direction).

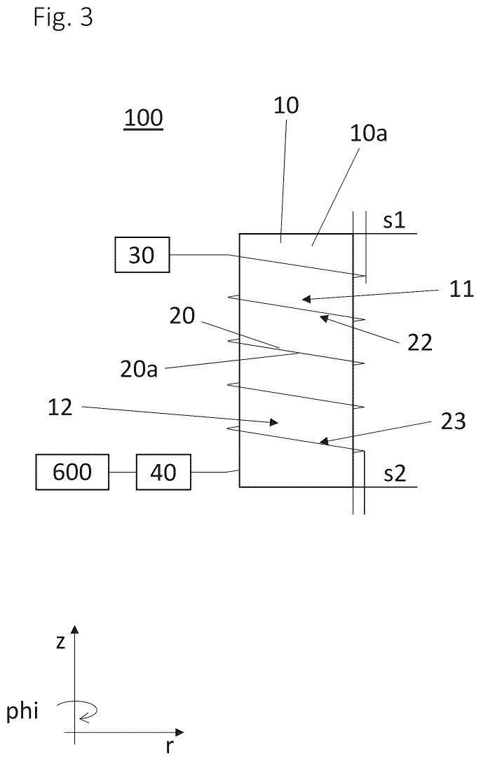

FIG. 3 shows a design of a system 100 in a schematic depiction. The system 100 comprises a radiation source 10 and a separation column 20. Additionally, the system 100 may comprise a detector 600. Through an inlet 30, e.g. through the injector 300, as depicted in FIG. 1, the separating substance mixture may be applied to the separation column 20. The substance mixture may flow through the separation column 20 to separate substances of the substance mixture. The separated substances of the substance mixture may flow out through an outlet 40, for example, to the detector 600.

The separation column 20 comprises a first section 21. The first section 21 of the separation column 20, in this example, is wrapped around the radiation source 10. The separation column 20 may be configured in a coil-shaped or helically shaped way at least in the first section 21. In this example, the winding in the first section 21 may be configured cylindrically.

The first section 21 of the separation column comprises a first subsection 22 and a second subsection 23. An interval s1 between the first subsection 22 and the radiation source 10 is identical to an interval s2 between the second subsection 23 and the radiation source 10.

In this example, the radiation source 10 may be formed in a bar shape. The radiation source 10 may emit electromagnetic radiation with a same intensity throughout the radiation-emitting section of the radiation source 10.

The radiation source 10 may comprise a coating 10a. For example, the radiation source 10 comprises a first section 11 and a second section 12. At least the second section 12 may be provided with the coating 10a. Through the coating, the intensity of the electromagnetic radiation radiated or emitted by the second section 12 may be lower than in the first section 11. In the first section 11, no coating 10a may be provided or a coating 10a may be provided that causes a smaller reduction of the intensity of the electromagnetic radiation.

Electromagnetic radiation emanating from the first section 11 of the radiation source 10 may be received by the first subsection 22 of the separation column 20 with a higher intensity than electromagnetic radiation emanating from the second section 12 of the radiation source may be received by the second subsection 23 of the separation column. Thereby, the first subsection 22 of the separation column 20 may be heated more intensively than the second subsection 23 of the separation column, although the respective interval to the radiation source 10 is the same.

Alternatively or in addition to the coating 10a of the radiation source 10, the separation column 20 may be provided with a coating 20a. For example, the first subsection 22 may be provided with the coating 20a. Through the coating 20a, the absorption of the electromagnetic radiation emitted or radiated by the radiation source 10 may be increased. The second subsection 23 may comprise no coating 20a or may comprise a coating 20a that causes a small increase of the absorption of the electromagnetic radiation.

Similarly, the coating 20a may be provided in the second subsection 23. The coating 20a may increase the reflection of the electromagnetic radiation emitted or radiated by the radiation source 10. The first subsection 22 may comprise no coating 20a or comprise a coating 20a that causes a small increase of the reflection of the electromagnetic radiation.

Also, through the coating 20a of the separation column 20, electromagnetic radiation emanating from the first section 11 of the radiation source 10 may be received by the first subsection 22 of the separation column 20 with a higher intensity than electromagnetic radiation emanating from the second section 12 of the radiation source may be received by the second subsection 23 of the separation column. The first subsection 22 may be heated more intensively than the second subsection 23.

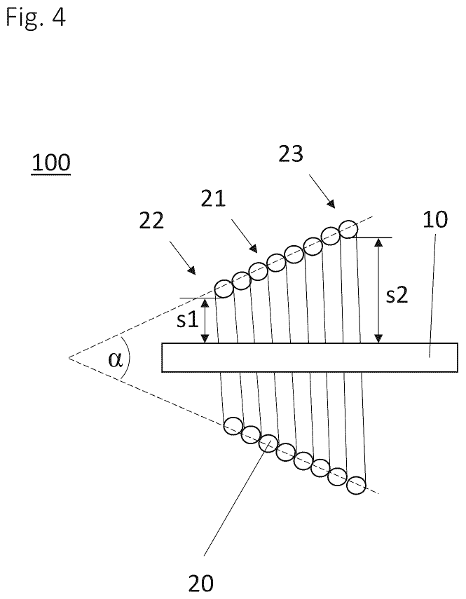

FIG. 4 schematically shows a design of a system 100. The system 100 is similar to the systems 100 described so far, so that a repetitive description of the same components is omitted. The system 100 of FIG. 4 may comprise one or more components or features of each system 100 disclosed herein.

In the sectional representation of FIG. 4, a continuous increase or a continuous decrease of the interval between the first section 21 of the separation column 20 and the radiation source 10 is shown. The continuous increase or continuous decrease may be uniform or linear.

The lowest interval s1 may exist at the first subsection 22. The largest interval s2 may exist at the second subsection 23. The first subsection 22 may exist closer to the inlet of the separation column 20. The second subsection 23 may exist closer to the outlet of the separation column 20.

The increase or decrease of the interval between the first section 21 of the separation column 20 and the radiation source 10 may be defined by an angle α. The angle α may be formed between two legs. Each of the legs may be an imaginary line through at least two adjacent windings, especially at least five adjacent windings, of the separation column 20 of the first section 21. In this course, the legs intersect in one point. The angle α may be between 1° and 70°, preferably between 1° and 60°, more preferably between 1° and 50°, more preferably between 5° and 40°, more preferably between 5° and 30°, more preferably between 5° and 20°.

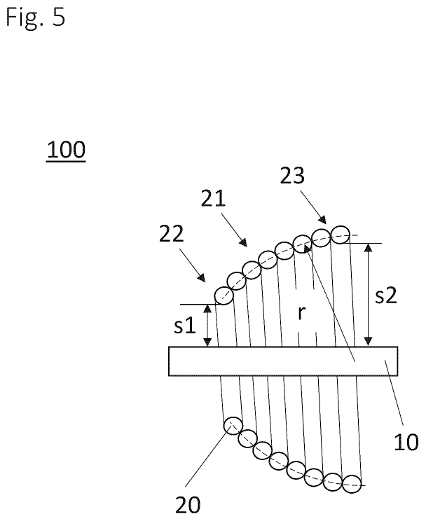

FIG. 5 schematically shows a design of a system 100. The system 100 is similar to the systems 100 described so far, so that a repetitive description of the same components is omitted. The system 100 of FIG. 5 may comprise one or more components or features of each system 100 disclosed herein.

In the sectional representation of FIG. 5, a continuous increase or a continuous decrease of the interval between the first section 21 of the separation column 20 and the radiation source 10 is shown. The continuous increase or continuous decrease may be irregular or nonlinear.

The lowest interval s1 may exist at the first subsection 22. The largest interval s2 may exist at the second subsection 23. The first subsection 22 may be closer to the inlet of the separation column 20. The second subsection 23 may be closer to the outlet of the separation column 20.

In the proximity of the inlet of the separation column 20, the increase or decrease of the interval may be more pronounced than in the proximity of the outlet of the separation column 20. Alternatively, the increase or decrease of the interval may be less pronounced in the proximity of the inlet of the separation column 20 than in the proximity of the outlet of the separation column 20.

Specifically, the increase or decrease of the interval may be described in the first section 21 of the separation column 20 by a radius r at least in sections. The extent of the radius r may be on an imaginary line through at least two adjacent windings, especially at least five adjacent windings, of the separation column 20 of the first section 21. The start point of the radius r (the center of the circle defined by the radius r) may be surround by the first section 21 of the separation column 20 or be outside the first section 21 of the separation column.

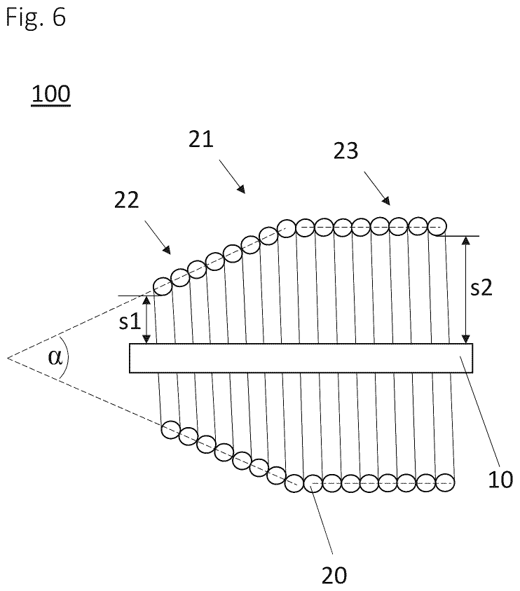

FIG. 6 schematically shows a design of a system 100. The system 100 is similar to the systems 100 described so far, so that a repetitive description of the same components is omitted. The system 100 of FIG. 6 may comprise one or more of components or features of each system 100 disclosed herein.

In the sectional representation of FIG. 6, a continuous increase or continuous decrease of the interval between the first section 21 of the separation column 20 and the radiation source 10 is shown in the first subsection 22. The continuous increase or continuous decrease may be uniform or linear. In the second subsection 23, the interval s2 may be constant.

In general, the first section 21 of the separation column 20 may comprise subsections with different distance progressions between the separation column 20 and the radiation source 10. For example, the interval between the separation column 20 and the radiation source 10 in the first subsection 22 may increase or decrease and the interval between the separation column 20 and the radiation source 10 in the second subsection 23 may be constant. Alternatively, the interval between the separation column 20 and the radiation source 10 in the second subsection 23 may increase or decrease and the interval between the separation column 20 and the radiation source 10 in the first subsection 22 may be constant.

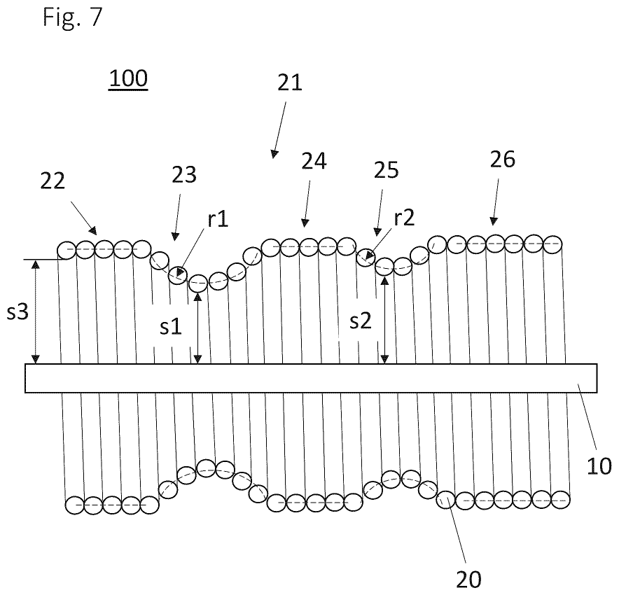

FIG. 7 schematically shows a design of a system 100. The system 100 is similar to the systems 100 described so far, so that a repetitive description of the same components is omitted. The system 100 of FIG. 7 may comprise one or more of components or features of each system 100 disclosed herein.

In the sectional representation of FIG. 7, a first section 21 of a separation column 20 is shown. The first section 21 may comprise a first subsection 22, a second subsection 23, a third subsection 24, a fourth subsection 25, and a fifth subsection 26.

In the first subsection 22, the third subsection 24, and the fifth subsection 26, the interval s3 between the separation column 20 and the radiation source 10 may be constant.

Between the first subsection 22 and the third subsection 24, the second subsection 23 may be formed. In the second subsection 23 the interval s1 between the separation column 20 and the radiation source 10 may change. The change of the interval s1 may be described by a radius r1. The extent of the radius r1 may be on an imaginary line through at least two adjacent windings, especially at least five adjacent windings, of the second subsection 23. The start point of the radius r1 (the center of the circle defined by the radius r1) may be outside the first section 21 of the separation column 20.

Between the third subsection 24 and the fifth subsection 26, the fourth subsection 25 may be formed. In the fourth subsection 25 the interval s2 between the separation column 20 and the radiation source 10 may change. The change of the interval s2 may be described by a radius r2. The extent of the radius r2 may be on an imaginary line through at least two adjacent windings, especially at least five adjacent windings, of the fourth subsection 25. The start point of the radius r2 (the center of the circle defined by the radius r2) may be outside the first section 21 of the separation column 20.

The radius r1 of the second subsection 23 may be larger than the radius r2 of the fourth subsection 25. Alternatively, the radius r1 of the second subsection 23 may be smaller than the radius r2 of the fourth subsection 25.

None of the subsections 22 to 26 is imperatively necessary. At least two random ones of the subsections 22 to 26 are sufficient.

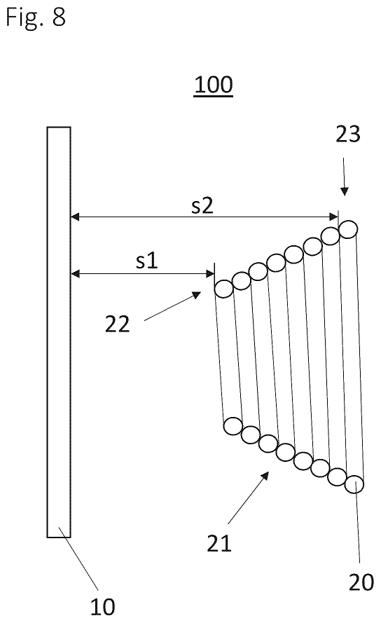

FIG. 8 schematically shows a design of a system 100. The system 100 is similar to the systems 100 described so far, so that a repetitive description of the same components is omitted. The system 100 of FIG. 8 may comprise one or more of components or features of each system 100 disclosed herein.

In the example of FIG. 8, the first section 21 of the separation column 20 may be formed in a coil-shape or a helical shape. The radiation source 10 may be configured planarly, for example as a round lamp, a surface emitter, or a lamp array. The first section 21 of the separation column 20 may not surround the radiation source 10. In other words, the radiation source 10 may be arranged outside the first section 21 of the separation column 20.

The first section 21 of the separation column 20 may be arranged towards the radiation source 10 such that a first subsection 22 of the separation column 20 has an interval s1 to the radiation source 10 and a second subsection 23 of the separation column has an interval s2 to the radiation source 10. The interval s1 between the radiation source 10 and the first subsection 22 may be smaller than the interval s2 between the radiation source 10 and the second subsection 23. Thereby, the first subsection 22 may receive a higher intensity of electromagnetic radiation from the radiation source 10 than the second subsection 23. The first subsection 22 may be heated more intensively than the second subsection 23.

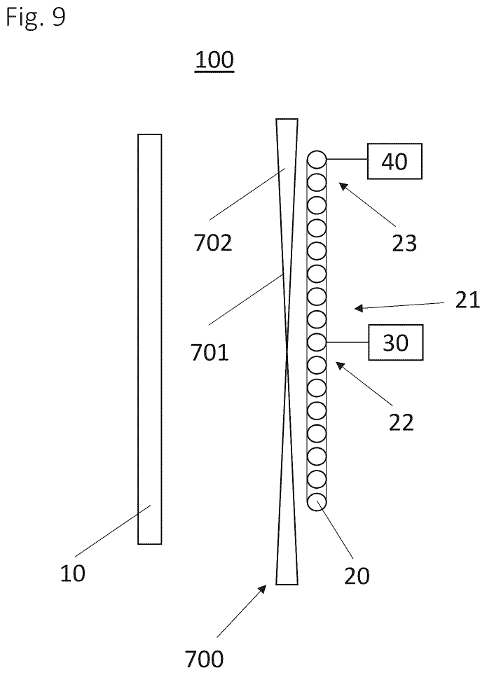

FIG. 9 schematically shows a design of a system 100. The system 100 is similar to the systems 100 described so far, so that a repetitive description of the same components is omitted. The system 100 of FIG. 9 may comprise one or more of components or features of each system 100 disclosed herein.

The first section 21 of the separation column 20 may be formed in a spiral shape. Preferably, the first section 21 of the separation column is configured planarly.

The radiation source 10 may be configured planarly, for example, as a round lamp, a surface emitter, or a lamp array. The first section 21 of the separation column 20 may not surround the radiation source 10. In other words, the radiation source 10 may be arranged outside the first section 21 of the separation column 20.

An interval between the first subsection 22 and the radiation source 10 may be identical to the interval between the second subsection 23 and the radiation source 10.

Between the radiation source 10 and the first section 21 of the separation column 20 a shield member 700 may be arranged. The shield member 700 may be an opacity element, a filter, a semitransparent element, and/or an element with a coating. The shield member 700 may comprise a first section 701 and a second section 702. The transmissive properties for the electromagnetic radiation of the radiation source may differ in a first section 701 of the shield member and in a second section 702 of the shield member 700.

The first section 701 of the shield member 700 may shield electromagnetic radiation from the radiation source 10 less strongly than the second section 701 of the shield member 700. The first section 701 of the shield member 700 may be associated to the first subsection 22 of the separation column 20. The second section 702 of the shield member 700 may be associated to the second subsection 23 of the separation column 20. Thereby, the first subsection 22 of the separation column 20 may receive electromagnetic radiation from the radiation source with a higher intensity than the second subsection 23.

The first subsection 22 of the separation column 20 may be arranged closer to the inlet 30 of the separation column 20 than to the outlet 40 of the separation column 20. The second subsection 23 of the separation column 20 may be arranged closer to the outlet 40 of the separation column 20 than to the inlet 30 of the separation column 20.

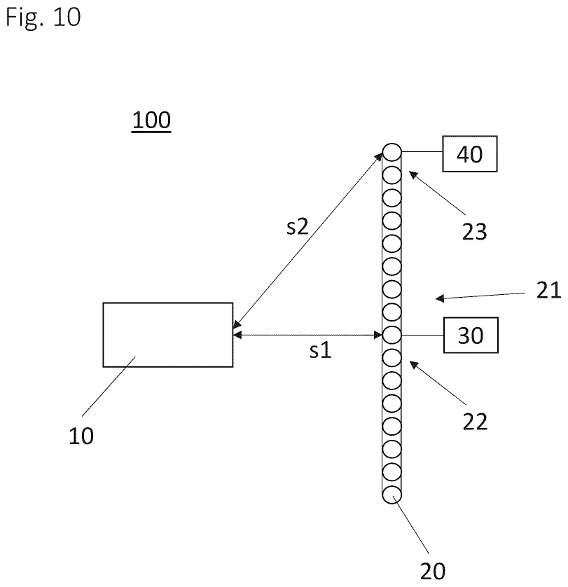

FIG. 10 schematically shows a design of a system 100. The system 100 is similar to the systems 100 described so far, so that a repetitive description of the same components is omitted. The system 100 of FIG. 10 may comprise one or more of components or features of each system 100 disclosed herein.

The first section 21 of the separation column 20 may be formed in a spiral shape. Preferably, the first section 21 of the separation column is configured planarly. The radiation source 10 may be formed as point radiation source.

Between the first subsection 22 of the separation column 20 and the radiation source 10 may exist an interval s1. Between the second subsection 23 of the separation column 20 and the radiation source 10 may exist an interval s2. The interval s1 between the first subsection 22 of the separation column 20 and the radiation source 10 may be smaller than the interval s2 between the second subsection 23 of the separation column 20 and the radiation source 10. Thereby, the first subsection 22 may be heated more intensively by the electromagnetic radiation of the radiation source 10 than the second subsection 23.

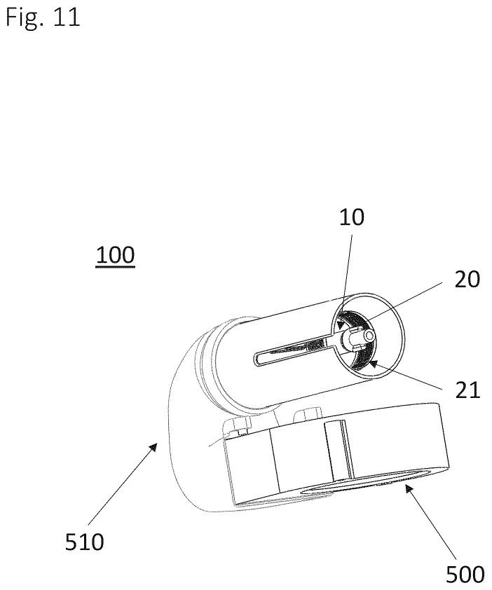

FIG. 11 shows a design of a system 100. The system 100 is similar to the systems 100 described so far, so that a repetitive description of the same components is omitted. The system 100 of FIG. 11 may comprise one or more of components or features of each system 100 disclosed herein.

The radiation source 10 of the system 100 may be formed in a bar shape. The first section 21 of the separation column 20 may be formed in a coil shape or in a helical shape and especially surround the radiation source 10.

The system 100 may comprise a fan 500. The fan 500 may be formed as a radial fan. Through a deflector 510, an air flow radially exiting from the fan 500 may be redirected. The redirected air flow may flow around the radiation source 10 and/or the first section 21 of the separation column 20 in the axial direction of the radiation source 10 to cool the radiation source 10 and/or the first section 21 of the separation column 20.

In the following, numbered examples of the disclosure are described.

1. A system (100) for separating substances in a substance mixture, the system with a radiation source (10) and a separation column (20), wherein
the separation column (20) comprises at least a first section (21), the first section (21) comprising at least a first subsection (22) and a second subsection (23);
the radiation source (10) is configured to radiate electromagnetic radiation in the direction of the first section (21) to heat the first section (21); and
the electromagnetic radiation is receivable in the first subsection (22) of the separation column (20) with a higher intensity than in the second subsection (23) of the separation column (20), so that the first subsection (22) is heatable more intensively than the second subsection (23).

2. The system of example 1, the radiation source (10) comprising a larger longitudinal development (z) than lateral development (r) and, preferably, the first section (21) of the separation column (20) extending coil-shaped or helically shaped around the radiation source (10), or the radiation source (10) being formed planarly.

3. The system of example 1 or 2, wherein the first section (21) of the separation column (20) is spaced from the radiation source (10) and/or wherein a temperature gradient can be formed along the first section (21) of the separation column (20) at least in sections.

4. The system of one of the previous examples, wherein an interval (s1) between the first subsection (22) and the radiation source (10) is smaller than an interval (s2) between the second subsection (22) and the radiation source (10).

5. The system of one of the previous examples, wherein the separation column (20) extends conically at least in sections, especially extends conically around the radiation source (10) at least in sections.

6. The system of one of the previous examples, wherein an interval between the separation column (20) and the radiation source (10) in the first section (21) increases or decreases at least in sections, especially over a length of the separation column of at least 10 mm, preferably at least 100 mm.

7. The system of one of the previous examples, wherein the separation column (20) is formed rigidly or fixedly at least in the first section (21); or wherein the separation column (20) is formed movably or variably in its shape at least in the first section (21).

8. The system of one of the previous examples, wherein the system (100) comprises a mount and wherein the separation column (20) is being held by the mount at least in sections.

9. The system of example 8, wherein a shape of the mount is adjustable, so that a shape of the separation column (20) changes at least in the first section (21).

10. The system of example 9, wherein through the change of the shape of the separation column (20) in at least the first section (21), the intensity of the electromagnetic radiation receivable in the first subsection (22) and/or in the second subsection (23) changes.

11. The system of one of the previous examples, wherein the separation column (20) is provided with a coating (20a) at least in sections, the coating (20a) affecting the intensity of the receivable electromagnetic radiation.

12. The system of example 11, wherein the coating (20a) affects the absorption and/or reflection of the electromagnetic radiation.

13. The system of one of the previous examples, the radiation source (10) comprising a first section (11) and a second section (12), wherein the first section (11) is configured to emit electromagnetic radiation in the direction of the first subsection (22) with a higher intensity than the second section (12) is configured to emit electromagnetic radiation in the direction of the second subsection (23).

14. The system of example 13, wherein the radiation source (10) is provided with a coating (10a) in at least the first section (11) and/or the second section (12).

15. The system of one of the previous examples, the electromagnetic radiation comprising infrared radiation.

16. The system of one of the previous examples, the system (100) comprising a detector (600) for detecting the substances.

17. The system of one of the previous examples, wherein the first section (21) of the separation column (20) surrounds the radiation source (10).

18. The system of one of the previous examples, wherein a shield member (700) is arranged between the radiation source (10) and the separation column (20), the shield member (700) to shield part of the electromagnetic radiation of the radiation source (10).

19. The system of example 18, the shield member (700) comprising a first section (701) and a second section (702), the first section (701) to shield the electromagnetic radiation of the radiation source (10) less than the second section (702).

20. The system of example 18 or 19, wherein the shield member (700) is an opacity element, a filter, a semitransparent element, and/or an element with a coating.

21. A method for separating substances in a substance mixture, the method with the steps:
introducing the substance mixture to an inlet (30) of a separation column (20);
radiating electromagnetic radiation emanating from a radiation source (10) to at least a first section (21) of the separation column (20) to heat the first section (21), the separation column (20) receiving the electromagnetic radiation in a first subsection (22) of the first section (21) with a higher intensity than in a second subsection (23) of the first section (21), so that the first subsection (22) is heated more intensively than the second subsection (23); and
deploying the separated substance mixture from an outlet (40) of the separation column (20).

22. The method of example 21, wherein the electromagnetic radiation comprises infrared radiation and/or wherein a temperature gradient is formed along the first section (21) of the separation column (20) at least in sections.

23. A method for analyzing substances in a substance mixture, the method with the steps:
performing the method of example 21 or 22; and
detecting, by a detector (600), substances in the separated substance mixture.

24. A separation column (20) for separating substances in a substance mixture, wherein
the separation column (20) comprises at least a first section (21) wrapped around a central axis;
the first section (21) comprises a first subsection (22) and a second subsection (23); and
the first subsection (22) is configured to receive electromagnetic radiation with a higher intensity than the second subsection (23), so that the first subsection (22) is heatable by the electromagnetic radiation more than the second subsection (23).

25. The separation column of example 24, wherein the electromagnetic radiation is receivable emanating from the central axis in the first subsection (22) and the second subsection (23).

26. The separation column of example 24 or 25, wherein an interval between the first subsection (22) and the central axis is smaller than an interval between the second subsection (22) and the central axis.

27. The separation column of one of the examples 24 to 26, wherein the separation column (20) extends conically around the central axis at least in sections.

28. The separation column of one of the examples 24 to 27, wherein an interval between the separation column (20) and the central axis in the first section (21) increases or decreases at least in sections, especially over a length of the separation column of at least 10 mm, preferably at least 100 mm.

29. The separation column of one of the examples 24 to 28, wherein the separation column (20) is formed rigidly or fixedly at least in the first section (21); or wherein the separation column (20) is formed movably or variably in its shape.

30. The separation column of one of the examples 24 to 29, wherein the separation column (20) is being held by a mount at least in sections.

31. The separation column of example 30, wherein a shape of the mount is adjustable, so that a shape of the separation column (20) changes at least in the first section (21).

32. The separation column of one of the examples 24 to 31, wherein the separation column (20) is provided with a coating (20a) at least in sections, the coating (20a) affecting the intensity of the receivable electromagnetic radiation in the first subsection (22) and/or the second subsection (23).

33. The separation column of example 32, wherein the coating (20a) affects the absorption and/or reflection of the electromagnetic radiation.

34. The separation column of one of the examples 24 to 33, wherein the separation column is formed in a spiral shape, a helical shape, or a coil shape.

### LIST OF REFERENCE SYMBOLS

1000 system for the analysis
10 radiation source
10a coating
11 first section
12 second section
20 separation column
20a coating
21 first section
22 first subsection
23 second subsection
30 inlet
40 outlet
100 system for the separation
200 gas supply member
300 injector
400 valve
500 fan
510 deflector
600 detector
700 shield member
800 housings

1-12. (canceled)

13. A system for separating substances in a substance mixture, said system having a radiation source and a separation column, wherein:
said separation column comprises at least a first section, said first section comprising at least a first subsection and a second subsection;
said radiation source is configured to radiate electromagnetic radiation in the direction of said first section to heat said first section, said electromagnetic radiation comprising infrared radiation; and
said electromagnetic radiation is receivable in said first subsection of said separation column with a higher intensity than in said second subsection of said separation column, so that said first subsection is heatable more intensively than said second subsection and a temperature gradient can be formed along said first section of said separation column,
wherein said first section of said separation column surrounds said radiation source,
wherein said first section has a length along said separation column of at least 500 mm and said electromagnetic radiation is receivable in said first section of said separation column so that said temperature gradient is formed along said first section.

14. The system of claim 13, wherein an interval (s1) between said first subsection and said radiation source is smaller than an interval (s2) between said second subsection and said radiation source.

15. The system of claim 13, wherein an interval between said separation column and said radiation source in said first section increases or decreases at least in sections.

16. The system of claim 15, wherein said radiation source in said first section increases or decreases at least in sections over a length of said separation column of at least 100 mm.

17. The system of claim 13, wherein said separation column is provided with a coating at least in sections, said coating affecting the intensity of the receivable electromagnetic radiation.

18. The system of claim 13, said radiation source comprising a first section and a second section, wherein said first section is configured to emit electromagnetic radiation in the direction of said first subsection with a higher intensity than said second section is configured to emit electromagnetic radiation in the direction of said second subsection.

19. The system of claim 13, wherein a shield member is arranged between said radiation source and said separation column, said shield member being configured to shield part of the electromagnetic radiation of said radiation source.

20. The system of claim 13, wherein a temperature difference of at least 5° C. is formed at said temperature gradient.

21. The system according to claim 20, wherein for determining said temperature difference the temperature at a first position of said separation column is compared with a temperature at a second position of said separation column and between said first position of said separation column and said second position of said separation column there is a distance along said separation column of at least 500 mm.

22. A method for separating substances in a substance mixture, the method comprising the steps:
introducing said substance mixture to an inlet of a separation column;
radiating electromagnetic radiation comprising infrared radiation emanating from a radiation source to at least a first section of said separation column to heat said first section, said separation column receiving said electromagnetic radiation in a first subsection of said first section with a higher intensity than in a second subsection of said first section, so that said first subsection is heated more intensively than said second subsection and a temperature gradient is formed along said first section of said separation column, wherein said first section of said separation column surrounds said radiation source, wherein said first section has a length along said separation column of at least 500 mm and said electromagnetic radiation is receivable in said first section of said separation column so that said temperature gradient is formed continuously along said first section; and
deploying said separated substance mixture from an outlet of said separation column.

23. The method of claim 22, wherein a temperature difference of at least 5° C. is formed at said temperature gradient.

24. The system of claim 23, wherein for determining said temperature difference the temperature at a first position of said separation column is compared with a temperature at a second position of said separation column and between said first position of said separation column and said second position of said separation column there is a distance along said separation column of at least 500 mm.

25. A method for analyzing substances in a substance mixture, the method with the steps:
performing the method of claim 22; and
detecting, by a detector, substances in said separated substance mixture.

26. A separation column for separating substances in a substance mixture, wherein
said separation column comprises at least a first section wrapped around a central axis;
said first section comprises a first subsection and a second subsection; and
said first subsection is configured to receive electromagnetic radiation with a higher intensity than said second subsection, so that said first subsection is heatable by said electromagnetic radiation more intensively than said second subsection,
wherein an interval between said first subsection and said central axis is smaller than an interval between said second subsection and said central axis.

27. The separation column of claim 26, wherein said separation column is provided with a coating at least in sections, said coating affecting the intensity of the receivable electromagnetic radiation in said first subsection and/or said second subsection.
